(19) United States
(12) Patent Application Publication
(10) Pub. No.: US 2009/0222248 A1
(43) Pub. Date: Sep. 3, 2009

(54) Method and system for determining a combined risk

(75) Inventors: Anthony James Grichnik, Peoria, IL (US); Christos Vasilios Nikolopoulos, Peoria, IL (US); James Robert Mason, Peoria, IL (US); Meredith Jaye Cler, Peoria, IL (US); Gabriel Carl Hart, North Pekin, IL (US)

Correspondence Address: CATERPILLAR/FINNEGAN, HENDERSON, L.L.P., 901 New York Avenue, NW, WASHINGTON, DC, 20001-4413, US

(73) Assignee: Caterpillar Inc.

(21) Appl. No.: 12/074,113

(22) Filed: Feb. 29, 2008

(51) Int. Cl. G06G 7/60

(52) U.S. Cl. 703/11

(57) ABSTRACT

A computer system for determining a combined risk is disclosed. The computer system has a memory, at least one input device, and a central processing unit in communication with the memory and the at least one input device. The central processing unit obtains diagnostic data and identifies a plurality of models for analyzing the diagnostic data. The central processing unit also associates each model with one of a plurality of time periods and calculates, for each time period using the associated model, a predicted risk. Further, the central processing unit determines the combined risk based on the predicted risk for each time period.

### TECHNICAL FIELD

This disclosure relates generally to diagnostic and prognostic monitoring, and, more particularly, to methods and systems for determining a combined risk.

### BACKGROUND

Mathematical models are often built to capture complex interrelationships between input parameters and output parameters. Various techniques may be used in such models to establish correlations between input parameters and output parameters. Once the models are established, the models predict the output parameters based on the input parameters. The accuracy of these models often depends on the environment within which the models operate.

One field in which modeling techniques are used is medical prognosis and treatment. A variety of different testing procedures, data analysis, and family history analysis can be used to predict a likelihood that a patient will develop various diseases. Multiple models may be used to predict the likelihood that a patient will develop a single disease. For example, one model may be an accurate predictor for whether females will develop heart disease, while another model may be an accurate predictor for whether a male will develop heart disease. Also, models for the same disease may have varying accuracy depending on the prognostic time frame. For example, one model may be able to accurately predict cancer onset within six months, while another model may more accurately predict cancer onset within a longer time period, such as five to ten years.

One tool that has been developed for mathematical modeling in the medical field is U.S. Pat. No. 6,669,631 to Norris et al. (the '631 patent). The '631 patent describes a system and method for employing mathematical modeling and trend analysis to form a patient specific medical profile. The '631 patent uses predictive models to prospectively anticipate future health problems and recommend a proactive/preemptive course of action.

Although the tool of the '631 patent uses mathematical modeling to anticipate future health problems, the '631 patent does not employ different models for different prognostic time periods. Because mathematical models may only be accurate over a given time range (e.g., predicting a disease onset within the next three months), applying a single or multiple models over an indefinite time period can lead to inaccurate prognosis. In the field of medical prognostics, accuracy in identifying the likelihood and timing of disease onset is vital to forming a proper preventative treatment plan. Physicians and patients would prefer a system and method that uses different models based on the prognostic time period within which each model is most accurate, allowing the opportunity to obtain an accurate prognosis and maximize the change of survival.

The present disclosure is directed to overcoming one or more of the problems set forth above.

### SUMMARY OF THE INVENTION

In accordance with one aspect, the present disclosure is directed toward a computer readable medium, tangibly embodied, including a tool for determining a combined risk. The computer readable medium includes instructions for obtaining diagnostic data and identifying a plurality of models for analyzing the diagnostic data. The computer readable medium also includes instructions for associating each model with one of a plurality of time periods and calculating, for each time period using the associated model, a predicted risk. Further, the computer readable medium includes instructions for determining the combined risk based on the predicted risk for each time period.

According to another aspect, the present disclosure is directed toward a method for determining a combined risk. The method includes obtaining diagnostic data and identifying a plurality of models for analyzing the diagnostic data. The method also includes associating each model with one of a plurality of time periods and calculating, for each time period using the associated model, a predicted risk. Further, the method includes determining the combined risk based on the predicted risk for each time period.

According to another aspect, the present disclosure is directed to a computer system including a memory, at least one input device, and a central processing unit in communication with the memory and the at least one input device. The central processing unit may obtain diagnostic data and identify a plurality of models for analyzing the diagnostic data. The central processing unit may also associate each model with one of a plurality of time periods and calculate, for each time period using the associated model, a predicted risk. Further, the central processing unit may determine a combined risk based on the predicted risk for each time period.

### BRIEF DESCRIPTION OF THE DRAWINGS

FIG. 1 is a block illustration of an exemplary disclosed system for determining a combined risk.

FIG. 2 is a flowchart illustration of an exemplary disclosed method of determining a combined risk.

### DETAILED DESCRIPTION

Reference will now be made in detail to exemplary embodiments, which are illustrated in the accompanying drawings. Wherever possible, the same reference numbers will be used throughout the drawings to refer to the same or like parts.

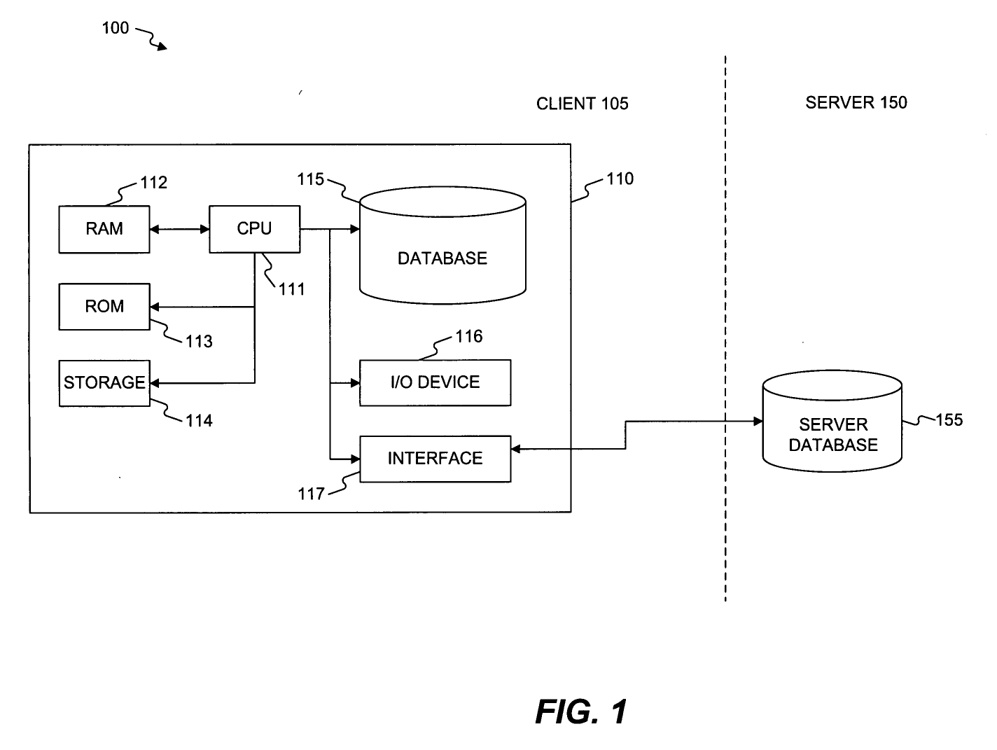

FIG. 1 provides a block diagram illustrating an exemplary environment 100 for determining a combined risk. Environment 100 may include a client 105 and server 150. Server 150 may include one or more server databases 155 for analyzing data input from client 105 and for determining a combined risk. Client 105 may include, for example, a doctor's office, a health insurance company, a medical research facility, or any other suitable medical facility. Client 105 may collect and analyze health data for patients in a variety of manners. For example, client 105 may measure a patient's blood pressure, weight, and cholesterol level. Client 105 may also collect data from other medical databases, such as a database of an insurance company. Server 150 may be, for example, an insurance company, or any other facility arranged to process and analyze medical data using modeling techniques. Although illustrated as a single client 105 and a single server 150, a plurality of clients 105 may be connected to either a single, centralized server 150 or a plurality of distributed servers 150.

System 110 may include any type of processor-based system on which processes and methods consistent with the disclosed embodiments may be implemented. For example, as illustrated in FIG. 1, system 110 may be a platform that includes one or more hardware and/or software components configured to execute software programs. System 110 may include one or more hardware components such as a central processing unit (CPU) 111, a random access memory (RAM) module 112, a read-only memory (ROM) module 113, a storage 114, a database 115, one or more input/output (I/O) devices 116, and an interface 117. System 110 may include one or more software components such as a computer-readable medium including computer-executable instructions for performing methods consistent with certain disclosed embodiments. One or more of the hardware components listed above may be implemented using software. For example, storage 114 may include a software partition associated with one or more other hardware components of system 110. System 110 may include additional, fewer, and/or different components than those listed above, as the components listed above are exemplary only and not intended to be limiting. For example, system 110 may include a plurality of sensors designed to collect data regarding a patient.

CPU 111 may include one or more processors, each configured to execute instructions and process data to perform one or more functions associated with system 110. As illustrated in FIG. 1, CPU 111 may be communicatively coupled to RAM 112, ROM 113, storage 114, database 115, I/O devices 116, and interface 117. CPU 111 may execute sequences of computer program instructions to perform various processes, which will be described in detail below. The computer program instructions may be loaded into RAM for execution by CPU 111.

RAM 112 and ROM 113 may each include one or more devices for storing information associated with an operation of system 110 and CPU 111. RAM 112 may include a memory device for storing data associated with one or more operations of CPU 111. For example, ROM 113 may load instructions into RAM 112 for execution by CPU 111. ROM 113 may include a memory device configured to access and store information associated with system 110, including information for determining a combined risk.

Storage 114 may include any type of mass storage device configured to store information that CPU 111 may need to perform processes consistent with the disclosed embodiments. For example, storage 114 may include one or more magnetic and/or optical disk devices, such as hard drives, CD-ROMs, DVD-ROMs, or any other type of mass media device.

Database 115 may include one or more software and/or hardware components that cooperate to store, organize, sort, filter, analyze, and/or arrange data used by system 110 and CPU 111. Database 115 may store data collected by system 110 that may be used to determine a combined risk. In the example of system 110 being a medical device, database 115 may store, for example, a patient's heart rate, blood pressure, and temperature as well as their diagnostic history, history of prescription medications, and other historical treatment information. The data may be generated by sensors, collected during experiments, retrieved from repair or medical insurance claims processing, although other data gathering techniques may be used. System 110 may also be employed to predict the failure of a machine, such as a vehicle. In this example, database 115 may store, for example, vehicle speed history, vehicle load history, environmental data such as a temperature and an air pressure, operating temperatures for coolant and oil, engine vibration levels, engine temperature, and oil conditions. Database 115 may also store one or more models for analyzing the data over different time periods, as described below. CPU 111 may access the information stored in database 115 and transmit this information to server system 155 for determining a combined risk.

I/O devices 116 may include one or more components configured to communicate information with a user associated with system 110. For example, I/O devices may include a console with an integrated keyboard and mouse to allow a user to input parameters associated with system 110. I/O devices 116 may also include a display, such as a monitor, including a graphical user interface (GUI) for outputting-information. I/O devices 116 may also include peripheral devices such as, for example, a printer for printing information and reports associated with system 110, a user-accessible disk drive (e.g., a USB port, a floppy, CD-ROM, or DVD-ROM drive, etc.) to allow a user to input data stored on a portable media device, a microphone, a speaker system, or any other suitable type of interface device.

The results of received data may be provided as an output from system 110 to I/O device 116 for printed display, viewing, and/or further communication to other system devices. Such an output may include the data collected by sensors attached to system 110. Output from system 110 can also be provided to database 115 and to server system 155.

Interface 117 may include one or more components configured to transmit and receive data via a communication network, such as the Internet, a local area network, a workstation peer-to-peer network, a direct link network, a wireless network, or any other suitable communication platform. In this manner, system 110 and server system 155 may communicate through the use of a network architecture (not shown). In such an embodiment, the network architecture may include, alone or in any suitable combination, a telephone-based network (such as a PBX or POTS), a local area network (LAN), a wide area network (WAN), a dedicated intranet, and/or the Internet. Further, the network architecture may include any suitable combination of wired and/or wireless components and systems. For example, interface 117 may include one or more modulators, demodulators, multiplexers, demultiplexers, network communication devices, wireless devices, antennas, modems, and any other type of device configured to enable data communication via a communication network.

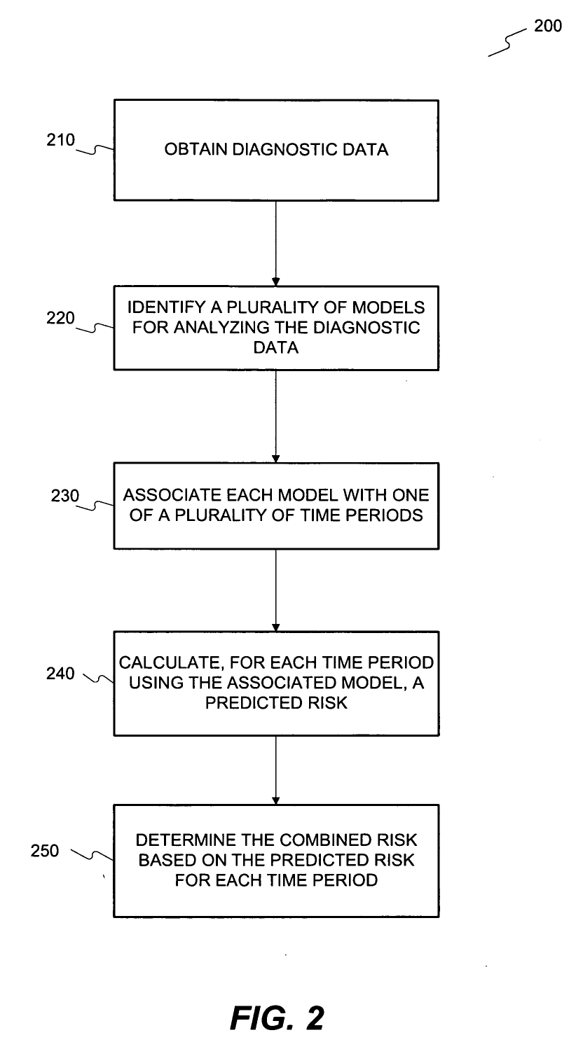

Server 150 may be, for example, a company or research facility that determines a combined risk based on data received from system 110. Server system 155 may collect data from a plurality of client systems (such as system 110) to analyze trends in historical data and determine a combined risk for a given patient or machine. Examples of collecting data and determining a combined risk will be described below with reference to FIG. 2.

Those skilled in the art will appreciate that all or part of systems and methods consistent with the present disclosure may be stored on or read from other computer-readable media. Environment 100 may include a computer-readable medium having stored thereon machine executable instructions for performing, among other things, the methods disclosed herein. Exemplary computer readable media may include secondary storage devices, like hard disks, floppy disks, and CD-ROM; or other forms of computer-readable memory, such as read-only memory (ROM) 113 or random-access memory (RAM) 112. Such computer-readable media may be embodied by one or more components of environment 100, such as CPU 111, storage 114, database 115, server system 155, or combinations of these and other components.

Furthermore, one skilled in the art will also realize that the processes illustrated in this description may be implemented in a variety of ways and include other modules, programs, applications, scripts, processes, threads, or code sections that may all functionally interrelate with each other to provide the functionality described above for each module, script, and daemon. For example, these programs modules may be implemented using commercially available software tools, using custom object-oriented code written in the C++ programming language, using applets written in the Java programming language, or may be implemented with discrete electrical components or as one or more hardwired application specific integrated circuits (ASIC) that are custom designed for this purpose.

The described implementation may include a particular network configuration but embodiments of the present disclosure may be implemented in a variety of data communication network environments using software, hardware, or a combination of hardware and software to provide the processing functions.

Processes and methods consistent with the disclosed embodiments may determine a combined risk and predict the likelihood of disease onset or loss of a bodily function (e.g., loss of a biological function). As a result, machine operators and doctors may monitor the status of machines and patients and determine the likelihood that a machine, component, or patient will suffer from a loss of function using a combination of models applied during for various prognostic time periods. By using a plurality of models over a plurality of time periods, the disclosed processes and methods may provide an accurate combined risk and provide preventative treatment for health problems or machine failure. Exemplary processes, methods, and user interfaces consistent with the invention will now be described with reference to FIG. 2.

### INDUSTRIAL APPLICABILITY

The disclosed methods and systems provide a desired solution for determining a combined risk in a wide range of applications, such as medical modeling, engine design, control system design, service process evaluation, financial data modeling, manufacturing process modeling, and many other applications. The disclosed process may monitor the performance of the system, process, or person being monitored and determine a combined risk by using a plurality of models to analyze diagnostic data during a plurality of time periods. By determining an accurate combined risk, environment 100 may avoid unnecessary pain and suffering by taking appropriate corrective actions prior to disease onset and, in the embodiment of machine maintenance, ensure optimal operation of machines.

FIG. 2 illustrates an exemplary disclosed method of determining a combined risk. System 110 may obtain diagnostic data for analysis (Step 210). For example, system 110 may collect a patient's medical records, blood pressure, cholesterol levels, gender, age, and other data needed for executing one or more models. In the embodiment of machine maintenance, diagnostic data may include, for example, air flow measurements through an air filter, crankcase pressure, oil filter pressure, engine coolant temperature, engine load, exhaust temperature, and other sensor data. The data may be collected continuously, on demand, or periodically.

Next, system 110 may identify a plurality of models for analyzing the diagnostic data (Step 220). Doctors, insurance companies, and medical researchers may develop a plurality of models to determine if a patient is likely to contract a disease. For example, several models may exist for diagnosing a patient with heart disease, such as the Framingham heart study. System 110 may select the appropriate models for analyzing a patient's likelihood for developing a given disease. Each model may utilize the same or different diagnostic data to predict the likelihood of disease onset. For example, a model for predicting heart disease onset in ten years may rely more heavily on hereditary factors, such as prior heart disease within a patient's family, whereas a model for predicting heart disease onset within the next two years may rely more heavily on measured values, such as blood pressure and cholesterol levels. While exemplary models have been described, numerous diagnostic models may be employed to predict disease onset as known in the medical field, such as the techniques described in U.S. Patent Application Publication No. 2007/0179769 by Grichnik et al.

System 110 may then associate each model with a plurality of time periods (Step 230). Models may have varying accuracy depending on an analytic time period. For example, one model may be accurate for predicting heart disease more distant in the future, such as in ten years, but lack sufficient accuracy for predicting disease onset in the near future. A second model may be accurate at predicting disease onset within a middle range, such as within the next two to five years. A third model may be most accurate a predicting disease onset in the near future, such as within the next two years. Accordingly, multiple models may have varying accuracy depending on the prognostic time period. System 110 may associate each model with the time periods in which the model most accurately predicts the likelihood of disease onset (or machine failure).

System 110 may determine the accuracy of models within varying time periods by, for example, analyzing historical data. In this example, system 110 may apply models to the medical history of several patients who either are known to have contracted or not contracted one or more diseases. System 110 may apply the models beginning at any time in the past and identify the time periods during which time the models most accurately predicted disease onset. The models that most accurately predicted disease onset may then be applied to determine a likelihood of disease onset in the associated time period for a current patient.

Next, system 110 may calculate, for each time period using the associated model, a predicted risk (Step 240). For example, assume system 110 identified three models for predicting heart disease onset in step 210. The first model may be most accurate at predicting heart disease onset more than two years in the future, the second model may be most accurate at predicting heart disease onset from six months to two years in the future, and the third model may be most accurate at predicting heart disease onset within the next six months. System 110 may analyze the diagnostic data needed using each model over the associated time periods to create a predicted risk for each time period. In this example, system 110 would calculate three predicted risks, although any number of predicted risks may be determined, depending on the number of models and time periods applied.

System 110 may then determine a combined risk based on the predicted risk for each time period (Step 250). Each model may provide a likelihood of the patient developing a risk over the corresponding time period. System 110 may recommend preventative treatments to a patient using the combination of the predicted risks. For example, assume that the first model indicated a patient has a thirty percent chance of developing heart disease more than two years in the future, a ten percent chance of developing heart disease between six months and two years into the future, and a five percent chance of developing heart disease within the next six months. Because the patient's greatest risk is distant in the future, the patient may undergo lifestyle changes, such as exercising regularly, to reduce his or her long term risk of developing heart disease. If, in contrast, the third model indicated a patient has, for example, a fifty percent chance of developing heart disease within the next six months, the patient may use a different preventative measure, such as taking medication.

System 110 may combine the predicted risks for each time period to provide a patient with a combined risk. Continuing with the example above, time periods may be equally weighted, such that the patient has a combined fifteen percent chance of developing heart disease ((30% for greater than two years+10% for six months to two years+5% for within six months)/3). System 110 may also combine the predicted risks into a graph to convey to a patient their likelihood of contracting a disease over varying future time periods.

System 110 may also use multiple models over the same time periods and combine the results of the models to provide a more accurate prognostic for a patient developing a disease, such as by averaging the results. For example, if three models indicate a patient has a fifteen percent, twenty percent, and twenty-two percent chance of contracting a disease within the next six months, system 110 may combine the results to indicate a nineteen percent chance ((15+20+22)/3=19). Although several exemplary methods for combining predicted risks to create a combined risk have been described, system 110 may combine the predicted risks in a variety of manners, such as by employing an analytical model. For example, system 110 may combine the predicted risks using forecasting techniques, such as those described in U.S. Pat. No. 7,213,007 to Grichnik et al.

The system may be designed for medical reasons to identify and predict people who are likely to be diagnosed with a disease, allowing preventative treatments or corrective actions to occur prior to disease onset. In the example of medical calculations, the data may include demographics, how other people with similar symptoms were treated (e.g., drugs, chemotherapy, physical rehabilitation), whether treatments were effective, and the survival rate for people diagnosed with similar diseases. By creating a combined risk using multiple models over varying time periods, the costs of healthcare may be reduced and the survival rate of patients may increase.

It will be apparent to those skilled in the art that various modifications and variations can be made to the disclosed methods. Other embodiments of the present disclosure will be apparent to those skilled in the art from consideration of the specification and practice of the present disclosure. It is intended that the specification and examples be considered as exemplary only, with a true scope of the present disclosure being indicated by the following claims and their equivalents.

What is claimed is:

1. A computer-implemented method for determining a combined risk, comprising:
obtaining diagnostic data;
identifying a plurality of models for analyzing the diagnostic data;
associating each model with one of a plurality of time periods;
calculating, for each time period using the associated model, a predicted risk;
determining the combined risk based on the predicted risk for each time period.

2. The computer-implemented method of claim 1, further including: selecting, for each model, a subset of the diagnostic data.

3. The computer-implemented method of claim 1, wherein the associating includes:
analyzing historical medical diagnostic data using the plurality of models;
determining which time period each model most accurately predicted disease onset; and
associating the most accurate models with the determined time periods.

4. The computer-implemented method of claim 1, further including determining the combined risk by averaging the predicted risks.

5. The computer-implemented method of claim 1, wherein the models include medical models for determining a likelihood of disease onset.

6. The computer-implemented method of claim 5, further including selecting a medical treatment plan for one or more diseases based on the combined risk.

7. The computer-implemented method of claim 1, wherein the diagnostic data includes at least one of data indicating a status of a component of one or more machines and data indicating a status of a biological function of one or more patients.

8. A computer-readable medium comprising instructions which, when executed by a processor, perform a method for determining a combined risk, the method comprising:
obtaining diagnostic data;
identifying a plurality of models for analyzing the diagnostic data;
associating each model with one of a plurality of time periods;
calculating, for each time period using the associated model, a predicted risk;
determining the combined risk based on the predicted risk for each time period.

9. The computer-readable medium of claim 8, wherein the method further includes:
selecting, for each model, a subset of the diagnostic data.

10. The computer-readable medium of claim 8, wherein the associating includes:
analyzing historical medical diagnostic data using the plurality of models;
determining which time period each model most accurately predicted disease onset; and
associating the most accurate models with the determined time periods.

11. The computer-readable medium of claim 8, wherein the method further includes determining the combined risk by averaging the predicting risks.

12. The computer-readable medium of claim 8, wherein the models include medical models for determining a likelihood of disease onset.

13. The computer-implemented method of claim 12, further including selecting a medical treatment plan for one or more diseases based on the combined risk.

14. The computer-implemented method of claim 8, wherein the diagnostic data includes at least one of data indicating a status of a component of one or more machines and data indicating a status of a biological function of one or more patients.

15. A computer system, comprising:
a memory;
at least one input device; and
a central processing unit in communication with the memory and the at least one input device, wherein the central processing unit:
obtains diagnostic data;
identifies a plurality of models for analyzing the diagnostic data;
associates each model with one of a plurality of time periods;
calculates, for each time period using the associated model, a predicted risk;
determines a combined risk based on the predicted risk for each time period.

16. The computer system of claim 15, wherein the central processing unit further selects, for each model, a subset of the diagnostic data.

17. The computer system of claim 15, wherein the associating includes:
analyzing historical medical diagnostic data using the plurality of models;
determining which time period each model most accurately predicted disease onset; and
associating the most accurate models with the determined time periods.

18. The computer system of claim 15, wherein the central processing unit further determines the combined risk by averaging the predicting risks.

19. The computer system of claim 15, wherein the models include medical models for determining a likelihood of disease onset.

20. The computer-implemented method of claim 19, further including selecting a medical treatment plan for one or more diseases based on the combined risk.
